(19) United States
(12) Patent Application Publication
(10) Pub. No.: US 2014/0361533 A1
(43) Pub. Date: Dec. 11, 2014

(54) PIPE CONNECTOR

(71) Applicant: Subsea Design A/S, Drammen (NO)

(72) Inventors: Bjørn PETTERSEN, Holmestrand (NO); Birger Vaage, Heggedal (NO)

(73) Assignee: Subsea Design A/S, Drammen (NO)

(21) Appl. No.: 14/466,718

(22) Filed: Aug. 22, 2014

Related U.S. Application Data
(63) Continuation-in-part of application No. 13/378,305, filed on Feb. 2, 2012.

(30) Foreign Application Priority Data
Jun. 15, 2009 (NO) 20092309

(51) Int. Cl. F16L 27/04

(52) U.S. Cl. CPC F16L 27/04
USPC 285/263

(57) ABSTRACT

A pipe connector comprises a sealing ring which has a conical outer surface at one end, and a convex spherical outer surface at the other end, or with spherical outer surfaces at both seal ends, a first pipe section interfacing with the conical or spherical outer surface of said sealing ring, a second pipe section interfacing with the convex spherical outer surface of said sealing ring, and a clamping device which can be adjusted radially and axially to interface with external surfaces of a first and second outer hubs on the first and second pipe sections.

### CROSS-REFERENCE TO RELATED APPLICATIONS

The present application is a continuation-in-part of and claims the benefit of priority through U.S. patent application Ser. No. 13/378,305, which is a United States National Stage application of International Application No. PCT/NO2010/000230, filed Jun. 15, 2010, which claims priority to Norwegian patent Application No. 20092309, filed Jun. 15, 2009, which issued as Norwegian Patent No. 331285. The present application hereby incorporates by reference the contents of each of the aforementioned applications in their entirety as if fully set forth herein.

### TECHNICAL FIELD OF THE INVENTION

The invention is a connector for pipes which are used for transportation of powder, grain, gas and fluids.

The connector is designed such that pipes with a moderate angular misalignment can be connected without bending of the pipes, and without loss of sealing capacity.

### BACKGROUND

Pipe flanges are often misaligned before connection. Common practice is to pull the flanges together with axial force and application of bending moment, until the flanges become parallel. This is necessary to generate sufficient preload of the flanges. FIG. 1 shows the principle.

The flange bolts, or a clamp, press the flanges (or hubs) together and generate two load paths in the process:
a) A primary load path between the flanges around each bolt or clamp interface.
b) A secondary load path between the flanges and the seal ring
   The load paths are shown in FIG. 1 as ribbons. The stresses in FIG. 1 are shown in tension (T), compression (C), and shear (S).

An axial force (P) will first reduce the compressive stress between the flanges, since the primary load path is more rigid than the secondary load path, The flanges will remain in contact as long as the axial force is less than the preload between the flanges, and there will be no significant additional stretching of the bolts, and no significant increase of the bolt loads.

Additional axial load after the flanges have separated will act directly on the bolts. The bolts will stretch, the flanges will move apart, the seal will slip in its seats and leakage will begin. The flange preload is what secures the connection against leakage.

Preloading of misaligned flanges will normally result in bending of the pipes, and induce permanent bending stresses in the pipes. This may require stronger pipes to resist the internal pressure in the pipes.

There are other types of connectors where the flanges are not in contact with each other, or only partly in contact. The preload between the flanges acts instead through the seal ring. See FIG. 2—The stresses in FIG. 2 are shown in tension (T), compression (C), and shear (S).

The seal has a small contact area against the flanges, and it is made from a relatively soft material, compared with the flanges. The preload must be low to avoid damaging the seal.

These connectors can be made up with an angle (e) between the pipe centerlines.

A tensile axial force will act practically directly on the bolts. The bolts will stretch, the flanges will move apart, the seal will slip in its seats, and leakage will begin. These connectors are not suitable for high pressure pipes.

### BRIEF DESCRIPTION OF THE DRAWINGS

FIG. 1 illustrates preloading of a common straight connector with stresses identified.

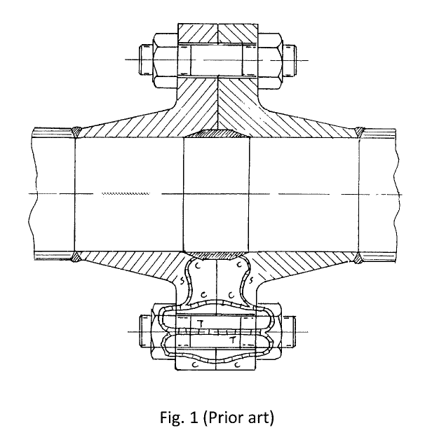

FIG. 2 illustrates preloading of a connector which allows some angular misalignment with stresses identified.

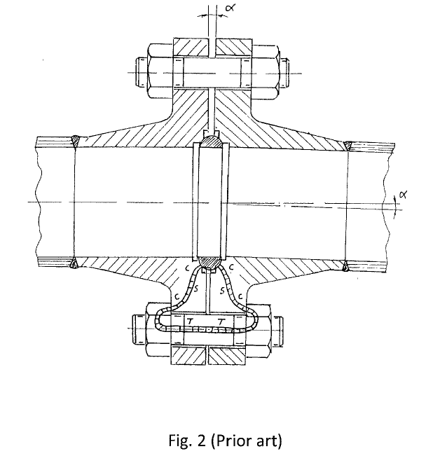

FIG. 3A illustrates a longitudinal section of an exemplary embodiment of a pipe connector.

FIG. 3B illustrates another embodiment of the inventive pipe connector.

FIG. 4 illustrates still another exemplary embodiment of a pipe connector.

In the drawings like characters of reference indicate corresponding parts in the different figures.

### DESCRIPTION OF THE INVENTION

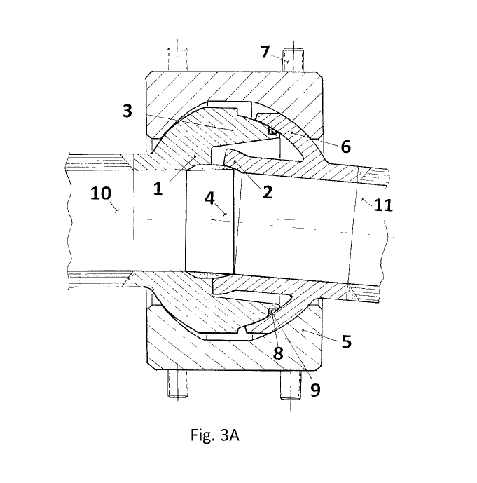

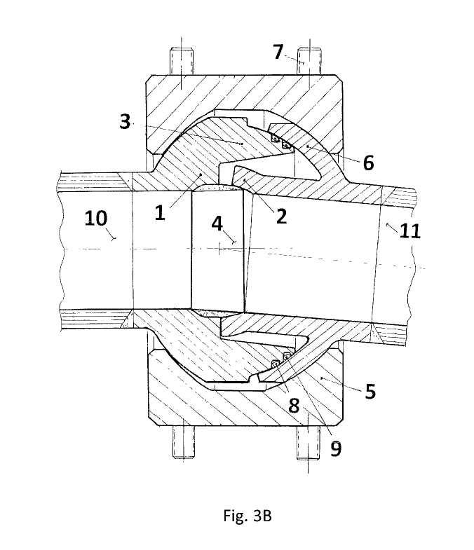

The present invention provides a pipe connector which avoids one or more of the above-mentioned drawbacks found with prior art connectors. The pipes can be connected without changing the angular misalignment. The connector is designed such that preload can still be achieved directly between the flanges, bypassing the seal. The connector is primarily intended as a static joint, where the angular misalignment (angle α in FIG. 3A) is constant after connection. FIG. 3A and 3B show sections through the invention.

The pipe connector consists of the following parts:

1) First inner hub

2) Second inner hub

3) First outer hub

4) Sealing ring

5) Clamp segment

6) Second outer hub

7) Clamp bolt

8) Environmental seal

9) Back-up seal

10) First pipe

11) Second pipe

The first outer hub (3) is firmly attached on the first inner hub (1) by interference fit or other mechanical means. This permits using different materials in the two. The inner hub may be machined from weldable steel—since it must be welded to the pipe (10), while the outer hub can be manufactured in non-weldable material. This can reduce the cost of the hubs. The same option is available for the second outer hub (6) and the second inner hub (2).

The inner surface of the first inner hub (1) interfaces with the spherical or conical outer surface of the sealing ring (4) and provides sealing of the first pipe (10).

The spherical inner surface of the second inner hub (2) interfaces with the spherical outer surface of the other end of the sealing ring (4), and provides sealing of the second pipe (11). These surfaces shall also provide sealing when there is an angular misalignment between the pipes.

Note that the location of the sealing ring, on the inside of both inner hubs, bridging the gap between the inner hubs, is unique among known connectors designed for connecting pipes with an angular misalignment.

The concave spherical inner surface of the second outer hub (6) interfaces with a convex spherical outer surface of the first outer hub (3). An environmental seal (8) may be installed between these two surfaces, to keep external media from entering into the connector; FIG. 3A. Installation of a back-up seal (9) for the sealing ring (4) is another option. The seals may be annular rings with at least a polymeric component, and are installed in a groove in first outer hub. The connector may also include both an environmental seal and a back-up seal, as shown in FIG. 3B,

The connector is held together by external clamp segments (5) and bolts (7). The clamp may be of any type suitable for the purpose. In the figures there are shown radial clamps, however axial clamps (a ring of each side of the connector, the rings being bolted together) may also be used.

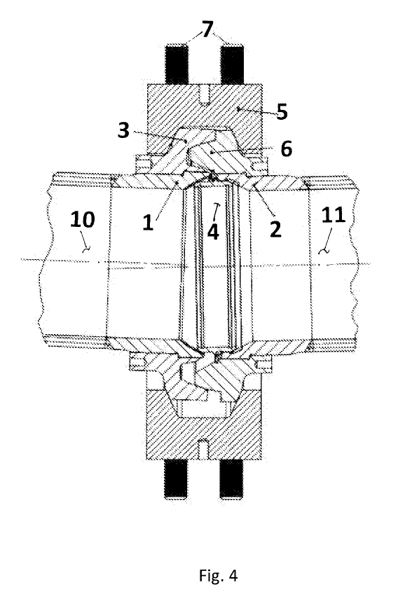

The clamp interfaces with the outer surfaces of the outer hubs (3 and 6). These outer surfaces will normally be convex spherical. For connectors designed for a small misalignment angle (up to 5 degrees) the outer surfaces of the outer hubs may be non-spherical. This is illustrated in FIG. 4,

The spherical surfaces at the interface between the first outer hub (3) and the second outer hub (6) shall primarily transfer axial force, and provide a load bypass of the sealing ring (4).

For connectors designed for misalignment up to 20 degree angle, it will be necessary to increase the (axial) width of the sealing ring, and reduce the inner diameter of the second inner hub (2) to keep the sealing ring trailing edge in contact with the hub (2) at large angles of misalignment. This will increase the pressure loss in the pipe flow, but this can be accepted in some cases.

The make-up sequence of the connector is as follows:

The sealing ring (4) is installed in the first inner hub (1).

The environmental seal (8) is installed in the first outer hub (3).

The second inner hub (2) is pushed against the seal (4), and the second outer hub (6) is pushed against the first outer hub (3).

The clamp segments (5) and bolts (7) are assembled outside the outer hubs.

Note that the loosely assembled clamp segments can be moved around on the (spherical) surface of the outer hubs, until they are positioned to produce maximum axial preload of the connector, when the bolts are tightened.

In one variant of the invention, the first outer hub (3) and the first inner hub (I) may be machined in one piece, from weldable steel. The same can be done with the second outer hub (6) and the second inner hub (2).

The connector may be used as a flex joint, where the angle (α) between the pipes can be varied after connection, The connector preload must then be reduced relative to that of a static joint, the friction factor of the moving contact surfaces must be reduced by selection of material, machining, coating etc. The sealing ring and environmental/back-up seals must be made to tolerate repeated movement, without leaking.

The connector may also be used as a safety element and allow the connection to rotate at a certain maximum external load, limiting the stresses in the connected pipes caused by an external bending moment.

1. A pipe connector for connection of pipes intended for operation at high pressure and temperature, but with an angular misalignment of up to 20 degrees, the joint being flexible during connection, allowing connection of the pipes without bending of the pipes, and without loss of sealing capacity, comprising:
a sealing ring made of metallic or composite material, which seals off the inside of the connector from the environment, and which has a conical outer surface at one end, and a convex spherical outer surface at the other end, or with spherical outer surfaces at both seal ends,
a first pipe section having a first inner hub with an internal conical surface for interfacing with the conical or spherical outer surface of said sealing ring, and a first outer hub with an external convex spherical surface,
a second pipe section having a second inner hub with an internal concave spherical surface which interfaces with the convex spherical outer surface of said sealing ring, and a second outer hub with a concave spherical inner surface which interfaces with the convex spherical outer surface of said first outer hub,
a clamping device which can be adjusted radially and axially to interface with external surfaces of the first and second outer hubs, and which is configured to press the hubs together during connection, such that the convex spherical surface of the first outer hub comes into firm contact with the concave spherical inner surface of the second outer hub, and the second inner hub is guided into contact with the convex spherical outer surface of the sealing ring, thus making contact between the two inner hubs via the sealing ring, such that a minor part of the axial compressive force generated by the clamping device acts via the inner hubs and the sealing ring, while the major part of the axial compressive force acts directly between the outer hubs, such that there will be insignificant relative axial movement between the inner hubs and the sealing ring when the pipe pressure varies.

2. A pipe connector according to claim 1, wherein the connector is provided with an environmental seal between the outer hubs to prevent intrusion of external medium into the connector.

3. A pipe connector according to claim 1, wherein the connector is provided with a seal between the outer hubs as back-up for the sealing ring.

4. A pipe connector according to claim 1, where the first inner hub and the first outer hub are made as one unit, and the second inner hub and the second outer hub are made as one unit.

5. A pipe connector according to claim 1, wherein the inner hubs are made from a material which is weldable to the pipe ends, and the outer hubs are made from materials which are different from the material of the inner hubs.

6. A pipe connector according to claim 5, where the first outer hub is interference fit to the outside of the first inner hub, and the second outer hub is interference fit to the outside of the second inner hub.

7. A pipe connector according to claim 1, wherein the clamping device has concave non-spherical contact surfaces with the outer hubs, such that the clamping device adjusts to the misalignment of the pipes during make-up, producing a uniform load distribution around the outer hubs.

8. A pipe connector according to claim 1, wherein the clamping device has concave spherical contact surfaces with the outer hubs.
